(19) United States
(12) Patent Application Publication
(10) Pub. No.: US 2012/0312519 A1
(43) Pub. Date: Dec. 13, 2012

(54) Partially composite plate

(75) Inventor: Birol Sonuparlak, Chandler, AZ (US)

(73) Assignee: Rogers Corporation, Rogers, CT (US)

(21) Appl. No.: 13/134,560

(22) Filed: Jun. 10, 2011

(51) Int. Cl. F28F 21/00; B32B 3/00; B32B 15/04

(52) U.S. Cl. 165/185; 428/457; 428/156

(57) ABSTRACT

A partially composite plate includes an area of metal matrix composite and a margin of metal, of the same metal as used to infiltrate the composite, along at least one edge of the composite. In a preferred embodiment of the invention, the margin surrounds the composite, the metal is aluminum, and the metal matrix composite is AlSiC.

### FIELD OF INVENTION

This invention relates to a cold plate and power module using the cold plate. In particular, the invention relates to a cold plate having at least one area of metal matrix composite and a margin of metal along at least one edge of the composite.

### BACKGROUND

Removing heat from high power semiconductor devices is a continuing problem as greater and greater amounts of power are controlled by such devices, e.g. in power modules for controlling electric motors, in power supplies, and in power conversion units. The problem is basically two-fold, removing heat rapidly and matching the coefficient of thermal expansion (CTE) of a semiconductor device or of a ceramic, such as alumina, having an adherent layer of direct bond copper (DBC). In general, DBC is a ceramic, such as alumina, aluminum nitride, silicon nitride, or beryllium oxide, having a copper layer, which may or may not be patterned, on one side and a continuous copper layer on the other for solder bonding to a metal matrix composite.

Matching CTE is particularly important to avoid stressing and failure of the semiconductor die attached to the layer. A material long recognized as suitable for this purpose is an AlSiC metal matrix composite. Such materials are characterized by high thermal conductivity and a coefficient of thermal expansion that substantially matches the coefficient of thermal expansion of the component being cooled.

Processes for making articles from metal matrix composites are long known in the art; e.g., see U.S. Pat. No. 5,348,071 (Cook). FIG. 1 is one example. In vessel 10, metal ingot 11 is located in a receptacle formed in the tops of mold halves 13 and 14. Pre-form 17 of porous matrix material fills closed mold halves 13 and 14. Vessel 10 is heated, e.g. by electric coil 18. When ingot 11 melts, the vessel is pressurized to force the metal to infiltrate the porous structure of pre-form 17 to produce a metal matrix composite. After cooling and solidification of the metal, the plate is removed from the mold.

Many materials are known in the art for making pre-form 17, depending upon the particular application. Silicon carbide, SiC, is among the more frequently used materials. Similarly, the infiltrating metal can be magnesium, zinc, iron, aluminum, copper, among others, as well as alloys of these metals. The use of the term “metal” does not exclude alloys.

FIG. 2 illustrates a metal matrix composite made as shown in FIG. 1. Dashed lines 19 refer to heat fins, also shown in FIG. 1. For high power electronic modules, plate 21 is AlSiC, a brittle material that is difficult, almost impossible, to machine. Thus, the mold and the pre-form must define the final shape of the plate, which causes a number of problems.

A first problem are the heat fins themselves. As used herein, “fins” includes pin and pyramidal structures, not just a blade-like structure. The number, shape, and size of the fins is limited because of the difficulty in removing the plate from the mold. Often the mold gets broken, even with careful design of the fins. For example, the sides of the heat fins must be slanted or tapered. Vertical sides on a heat fin would make it extremely difficult to remove the plate from the mold without breaking either the plate or the mold.

Similarly, the spacing of the heat fins is limited. If too close together, the mold becomes too delicate to withstand removal of the plate. Shape restrictions and relatively large spacing of the heat fins, e.g. a separation of 3.75 mm or more, also reduces the ability of the plate to remove heat from the surface opposite the heat fins. Direct bond copper layer 27 is on the surface opposite the heat fins for mounting one or more die, e.g. for high power switching transistors.

Attachment features, such as slot 23 and recess 25 must be in the pre-form prior to infiltration. Metal matrix composites are too hard and abrasive for later machining. This means that any design change requires new molds and new pre-forms to be made for manufacturing the part by casting. Thus, plate 21 is a relatively expensive article.

The plate illustrated in FIG. 2 is relatively small. Obviously, the problems associated with this plate, especially cost, increase disproportionately as one tries to make larger plates.

FIG. 3 illustrates a cooling chamber to which plate 21 (FIG. 2) is attached. Chamber 31 includes bolt holes, such as holes 33 and 34, for attaching the plate. Gasket 37 provides a seal. With a plate attached, chamber 31 has coolant circulated through it from supply and drain ports (not shown in FIG. 3). The coolant contacts the surface of the plate with the heat fins extending into the coolant. The system is prone to leakage.

It is known in the art to infiltrate a hollow cylindrical pre-form in a cylindrical mold, leaving a residue of aluminum within the cylinder surrounded by composite. The residue is scrap and later drilled out. See U.S. Pat. No. 6,137,237 (MacLennan et al.).

In view of the foregoing, it is therefore an object of the invention to provide a partially composite plate that can be machined easily even though it includes metal matrix composite.

Another object of the invention is to provide a partially composite plate that can be readily removed from a casting mold with substantially no breakage, thereby increasing the life of the casting mold and yield.

A further object of the invention is to reduce the cost of a composite plate by reducing the amount of the metal matrix composite in the plate, decreasing labor costs in removing the part from the mold, and increasing yield.

Another object of the invention is to provide partially composite plates that can be tiled to make a larger plate, rather than making a single large plate.

A further object of the invention to provide a more efficient, thermally conductive plate, i.e. one that conducts heat better than in the prior art by increasing fin density.

Another object of the invention is to provide a thermally conductive plate that can have an intricate heat fin structure, e.g. with a fin spacing of 3 mm or less.

A further object of the invention is to provide a thermally conductive plate that can have a dense (closely spaced) heat fin structure.

Another object of the invention is to provide a thermally conductive plate that can be hermetically sealed to a cooling chamber, i.e., fused to the cooling chamber, thereby eliminating the need for a gasket.

### SUMMARY OF THE INVENTION

The foregoing objects are achieved in the invention in which a partially composite plate includes an area of metal matrix composite and a margin, of the same metal as used to infiltrate the composite, along at least one edge of the composite. In a preferred embodiment of the invention, the margin surrounds the composite, the metal is aluminum, and the metal matrix composite is AlSiC.

### BRIEF DESCRIPTION OF THE DRAWINGS

A more complete understanding of the invention can be obtained by considering the following detailed description in conjunction with the accompanying drawings, in which:

FIG. 1 illustrates making a metal matrix composite in accordance with the prior art;

FIG. 2 illustrates a thermally conductive plate made entirely of metal matrix composite in accordance with the prior art;

FIG. 3 is a perspective view of a cooling chamber of the prior art to which a thermally conductive plate of the prior art is attached;

FIG. 4 illustrates making a partially composite plate in accordance with one aspect of the invention;

FIG. 5 is a perspective view of the top surface of a partially composite plate constructed in accordance with the invention;

FIG. 6 is a perspective view of the bottom surface of a partially composite plate constructed in accordance with the invention;

FIG. 7 illustrates tiling partially composite plates constructed in accordance with the invention in order to make a single, larger plate; and

FIG. 8 is a perspective view of a high power, electronic module including partially composite plates constructed in accordance with the invention.

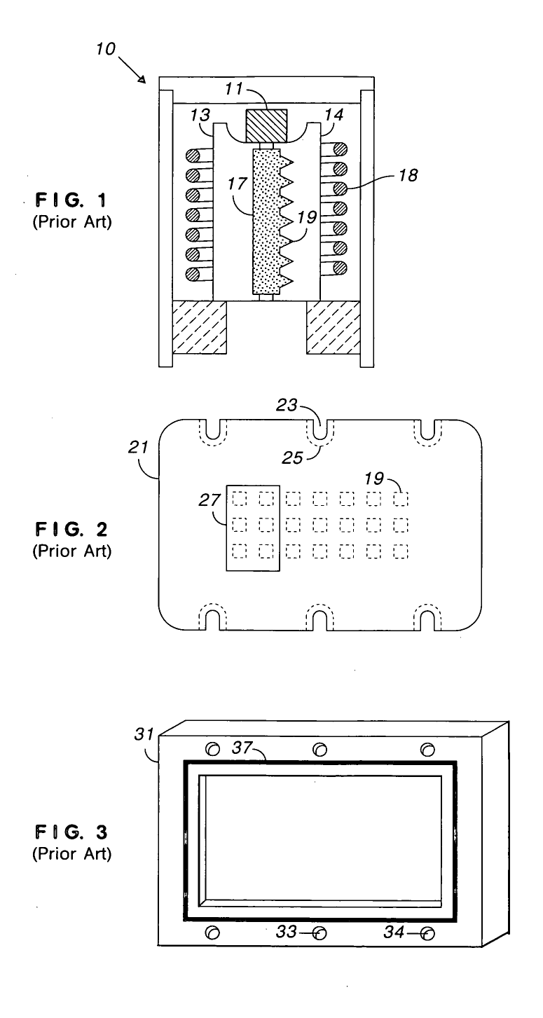

### DETAILED DESCRIPTION OF THE INVENTION

As used herein, a “plate” is a planar (substantially two dimensional), relatively thin, rigid body of approximately uniform thickness, ignoring surface features, such as heat fins. Conductive plates made in accordance with the invention are dimensionally similar to conductive plates of the prior art, wherein specific dimensions vary with application.

As used herein, a “margin” is an the area between a composite within a plate and an edge of the plate or the area between composites. A margin is not scrap or residue or surplus but a part of a plate.

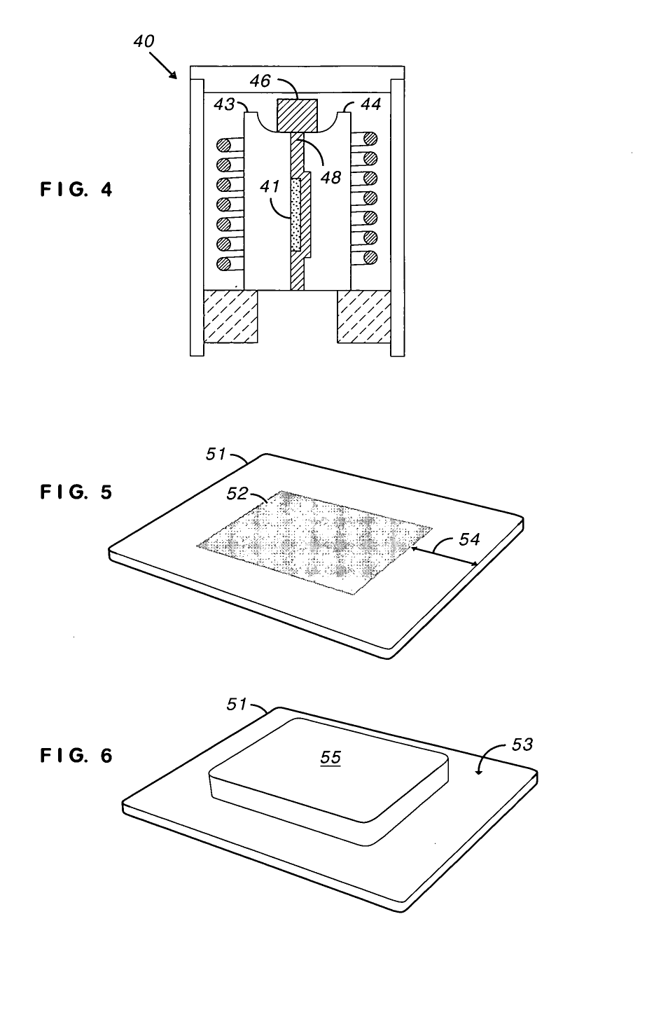

FIG. 4 illustrates a process for making a plate in accordance with the invention. In accordance with one aspect of the invention, pre-form 41 is smaller than the volume contained by closed mold halves 43 and 44. As a result, when metal ingot 46 melts, it fills the rest of the mold, indicated by cross-hatched area 48, and infiltrates pre-form 41 when vessel 49 is pressurized. A shallow recess in mold half 43, e.g., ≈0.25 mm deep, can be used to hold pre-form 41 in place.

FIG. 5 illustrates the top surface of a plate constructed in accordance with the invention. Plate 51 includes area 52 of metal matrix composite having margin 54 of metal along at least one edge of the composite. In a preferred embodiment of the invention, the margin surrounds the composite, the metal is aluminum, and the metal matrix composite is AlSiC. The shape of area 52 is arbitrary but sufficient to provide ample mounting area for DBC, on which one or more semiconductor die are mounted. The margins need not be the same width on all edges of the composite. Visually, area 52 is a slightly but perceptibly different shade of gray from margin 54. Area 52 has the same thickness as pre-form 41 (FIG. 4). Because pre-form 41 is smaller and simpler in shape, cost is substantially reduced. The thickness of the pre-form 41 can be reduced, compared with the prior art, for further cost saving.

Margin 54 is aluminum and can easily be machined to any desired shape or dimension to fit a cooling chamber. Cooling chambers are typically made from aluminum. Thus, margin 54 is welded to the cooling chamber, forming essentially a unitary structure with no gasket.

FIG. 6 illustrates the bottom surface of a plate constructed in accordance with the invention. Extending outward from bottom surface 53 is mesa 55. The mesa has a simple shape and slightly tapered sides, making it relatively easy to remove from a mold. Removal is also easier because of the large difference in CTE between the casting mold and the aluminum. The CTE of aluminum, 22×10⁻⁶/K, is much higher than the CTE of a casting mold, 5−7×10⁻⁶/K. Aluminum shrinks away from the mold during cooling from the casting temperature.

In accordance with another aspect of the invention, mesa 55 is metal, not a composite. As seen in FIG. 4, there is a space between pre-form 41 and mold half 44. This space fills with metal as ingot 46 melts.

Mesa 55 provides the material from which heat fins can be machined easily. For example, parallel, spaced cutting blades can cut closely spaced heat fins with vertical sides in a single pass. Even more intricate shapes, including undercuts, can be made with a numerically controlled milling machine. Such shapes are impossible with the metal matrix composite plates of the prior art. In addition, the height of mesa 55 can be greater than the height of heat fins of the prior art, allowing the heat fins to extend further into coolant and further increasing the efficiency of the plate.

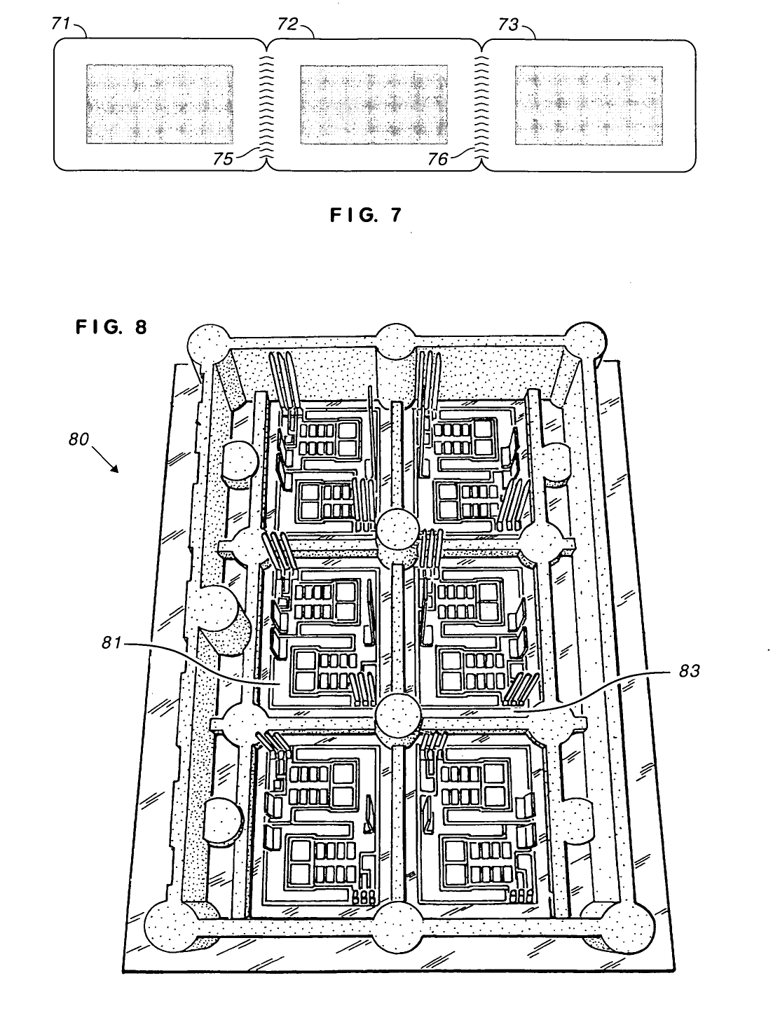

FIG. 7 illustrates a partially composite plate with three areas of metal matrix composite surrounded by a margin of metal. Plates 71, 72, and 73 are tiled by welding one edge of plate 71 to an edge of plate 72 and welding a second edge of plate 72 to one edge of plate 73. The result is a single larger plate with welds 75 and 76. Plates can be tiled in any configuration, e.g. an I-, U- or L-shaped plate, not obtainable from metal matrix composite plates of the prior art. By tiling, one obtains a larger plate at a fraction of the cost of such a plate in the prior art, if it were obtainable at all. The plates can be cast to allow a lap joint. Mesa 55 (FIG. 6) can be extended to an edge of the plate to produce a continuous fin structure when the plates are joined.

FIG. 8 illustrates an electronic power module based upon an existing design but using six separate plates constructed in accordance with the invention. As illustrated in FIG. 8, each plate, such a plate 81, is constructed in accordance with the invention. A DBC layer is bonded to the top surface of each plate and semiconductor devices are bonded to the DBC. Each plate is welded to a cooling chamber, such as chamber 83. Thus, partially composite plates constructed in accordance with the invention can be used as heat sinks to improve the performance of existing designs.

Plates constructed in accordance with the invention have high thermal conductivity, e.g. on the order of 160 W/mK, for aluminum and AlSiC. The conductivity and tighter fin structure allow one to reduce the size of a power module by tiling the partially composite plates. Even though the sources of heat are closer together, the high thermal conductivity of the plate provides sufficient cooling.

The invention thus provides a more efficient thermally conductive plate, i.e. one that conducts heat better than in the prior art, that can have a intricate heat fin structure, closely spaced heat fins, heat fins that can extend deeper into coolant than composite heat fins of the prior art. Longer and denser fins may allow air cooling instead of liquid cooling, further simplifying and lowering the cost of a power module. The invention also provides a thermally conductive plate that can be hermetically sealed to a cooling chamber, i.e., fused to the cooling chamber thereby eliminating the need for a gasket. The invention also provides a partially composite plate that can be readily removed from a mold with substantially no breakage, thereby increasing mold life and yield, a partially composite plate that can be machined easily even though it includes a metal matrix composite, and partially composite plates that can be tiled to make a larger plate, rather than making a large plate in a single mold. The invention reduces the cost of a composite plate by reducing the amount of metal matrix composite in the plate and enabling plates to be tiled to make a single, larger plate.

Having thus described the invention, it will be apparent to those of skill in the art that various modifications can be made within the scope of the invention. For example, AlSiC can be replaced with another material having a low CTE. The mesa can be a different material from the aluminum used in the casting, attached to the plate after casting. If the mesa is a forgeable material, it can be forged rather than machined. The mesa can be machined into microchannels, e.g. <1 mm fin spacing.

What is claimed as the invention is:

1. A partially composite plate characterized in that the plate includes at least one area of metal matrix composite and a margin of the same metal as used to infiltrate the composite, wherein said margin is along at least one edge of the composite.

2. The partially composite plate as set forth in claim 1 wherein the margin surrounds the metal matrix composite.

3. The partially composite plate as set forth in claim 2 wherein said metal is aluminum.

4. The partially composite plate as set forth in claim 3 wherein said metal matrix is AlSiC.

5. The partially composite plate as set forth in claim 1 including a mesa extending from the bottom surface of the plate.

6. The partially composite plate as set forth in claim 5 wherein said mesa is composed of said metal.

7. The partially composite plate as set forth in claim 6 wherein fins are formed in said mesa.

8. The partially composite plate as set forth in claim 7 wherein said fins have a separation of 3 mm or less.

9. The partially composite plate as set forth in claim 1 wherein said plate includes more than one area of metal matrix composite and the areas are separated by a margin of the same metal as used to infiltrate the composite.

10. An electronic power module comprising a partially composite plate, wherein the plate includes more than one area of metal matrix composite and the areas are separated by a margin of the same metal as used to infiltrate the composite.

11. The electronic power module as set forth in claim 10 wherein said metal is aluminum.

12. The electronic power module as set forth in claim 11 wherein said metal matrix is AlSiC.

13. The electronic power module as set forth in claim 12 wherein said module includes a cooling chamber and said partially composite plate is fused to the cooling chamber.

14. An electronic power module comprising a plurality of partially composite plates, wherein each plate includes an area of metal matrix composite and a margin of the same metal as used to infiltrate the composite, and wherein said margin is along at least one edge of said area.

15. The electronic power module as set forth in claim 14 wherein said metal is aluminum.

16. The electronic power module as set forth in claim 15 wherein said metal matrix is AlSiC.

17. The electronic power module as set forth in claim 16 wherein said module includes a plurality of cooling chambers and said partially composite plates are fused one to each cooling chamber.
